(19) United States
(12) Patent Application Publication
(10) Pub. No.: US 2006/0207572 A1
(43) Pub. Date: Sep. 21, 2006

(54) Control device of internal combustion engine

(75) Inventor: Fumio Yatabe, Tochigi-ken (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: KEIHIN CORPORATION, Tokyo (JP)

(21) Appl. No.: 10/553,684

(22) PCT Filed: Apr. 16, 2004
(86) PCT No.: PCT/JP04/05499

§ 371 Date: Oct. 17, 2005

(30) Foreign Application Priority Data
Apr. 21, 2003 (JP) 2003-115908

(51) Int. Cl. F02D 41/18

(52) U.S. Cl. 123/494

(57) ABSTRACT

A control apparatus is for an engine of a direct cylinder fuel-injection type that directly injects a fuel in a combustion chamber of a cylinder. The control apparatus includes an air flow meter which is positioned downstream from a throttle valve located in an air intake passage of the engine and which measures a quantity of air suctioned into the engine, and a control circuit which calculates a fuel injecting quantity in accordance with measurement information outputted from the air flow meter and which outputs a signal to an injector.

### TECHNICAL FIELD

The present invention relates to a control apparatus for controlling fuel injection in an internal combustion engine having direct cylinder fuel-injection. Priority is claimed on Japanese Patent application No. 2003-115908, filed Apr. 21, 2003, the content of which is incorporated herein by reference.

### BACKGROUND ART

Some internal combustion engines for vehicles provide a throttle valve at the upstream side of intake manifolds (air intake passages), and provide a fuel injection valve and an air flow rate sensor at the downstream side of the throttle valve (for example, refer to Japanese Examined Patent Application, Second Publication No. H04-15388). An intake air volume signal which is an output from the air flow rate sensor is input to a control circuit, and a fuel injection quantity is calculated in response to the operational state of the internal combustion engine. In addition, an injection quantity signal based on the calculated fuel injection quantity is output from a control circuit to control the operation of the fuel injection valve.

However, it is difficult to carry out optimum fuel injection at the start of opening of the throttle valve in the above-mentioned conventional configuration, because the air flow rate sensor measures the air flow rate which is obtained by adding the air filled in the air intake manifold to the air suctioned into the internal combustion engine, in a case where the pressure becomes a negative pressure in the air intake manifold. As a result, there is a problem in which the combustion efficiency of fuel is reduced. On the other hand, it is required that the above-mentioned problem be overcome in order to carry out further improvement, although an internal combustion engine is known which has an improved combustion efficiency of fuel by using direct cylinder fuel-injection in which the fuel is directly injected to a combustion chamber.

The present invention has been realized in view of the above-stated situations and has an object to provide a control apparatus for an internal combustion engine that is capable of accurately measuring an air intake quantity even at the start of opening of the throttle valve in an internal combustion engine having direct cylinder fuel-injection in order to carry out optimum fuel injection.

### DISCLOSURE OF INVENTION

The present invention provides a control apparatus for an internal combustion engine having direct cylinder fuel-injection type that directly injects a fuel in a combustion chamber of a cylinder. The control apparatus includes an air flow rate sensor which is positioned downstream from a throttle valve located in an air intake passage of the internal combustion engine and which measures a quantity of air suctioned into the internal combustion engine, and a control section which calculates a fuel injecting quantity in accordance with measurement information outputted from the air flow rate sensor and which outputs a signal to a fuel injecting device of the internal combustion engine.

According to the control apparatus for the internal combustion engine, it is possible to measure the quantity of only air which is suctioned into the internal combustion engine excluding the air filled in the air intake passage, even at the start of opening of the throttle valve in the operational status of the internal combustion engine, because the quantity of air suctioned into the internal combustion engine is measured by the air flow rate sensor which is positioned at the downstream from the throttle valve located in the air intake passage.

Furthermore, it is possible to carry out the fuel injection on the basis of the measurement information within one cycle of the internal combustion engine in real time when measuring an actual quantity of air which is suctioned into the internal combustion engine between the instant when the air intake valve opens and the instant when the air intake valve closes, because the internal combustion engine is the direct cylinder fuel-injection type.

In addition, it is possible to determine the start and the end of air intake, to calculate the air intake quantity, and to control the fuel injection timing on the basis of the information obtained by the air flow rate sensor, in a case where the air flow rate greatly varies downstream from the throttle valve of the air intake passage when the internal combustion engine starts the air intake or finishes the air intake.

### BRIEF DESCRIPTION OF THE DRAWINGS

FIG. 1 is a block diagram showing an internal combustion engine according to an embodiment of the present invention.

FIG. 2 shows graphs showing temporal variations of an air flow rate in an air intake passage, a lift amount of an air intake valve, and a command signal which is supplied to an injector, on driving the engine.

FIG. 3 shows a flowchart describing an operation of a control circuit.

### BEST MODES FOR CARRYING OUT THE INVENTION

An embodiment of the present invention will be explained below based on the drawings.

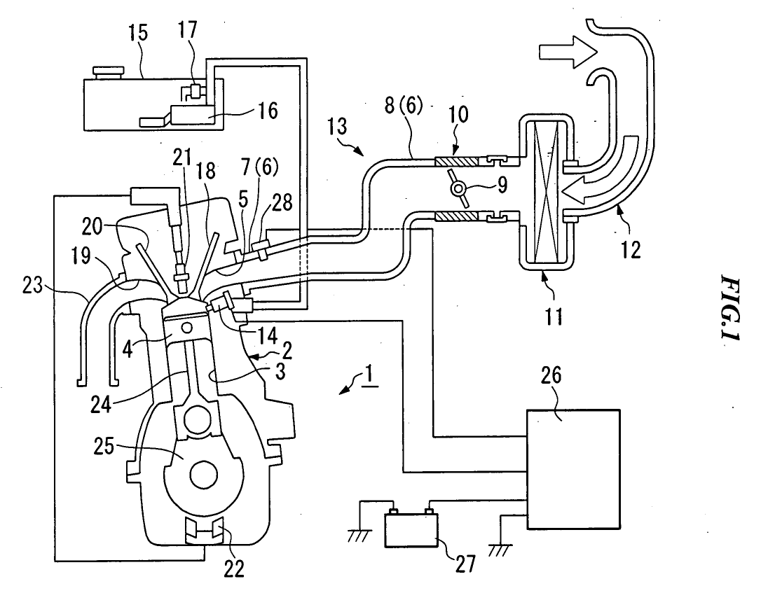

As shown in FIG. 1, an engine (internal combustion engine) 1 is a multi-cylinder reciprocating engine in which each piston 4 undergoes reciprocating linear motion in a plurality of cylinders 3 of an engine main body 2. The reciprocating motion of the piston 4 changes the volume in the cylinder 3, repeating each stroke of air intake, compression, combustion (expansion), and exhaust. Branch pipes 7 are positioned downstream from an air intake manifold 6 in the direction of air intake. Each of the branch pipes 7 is coupled to an external opening portion of an air intake port 5 which corresponds to each cylinder of the engine main body 2. A collecting pipe 8 is positioned at the upstream from the air intake manifold 6 in the direction of air intake. The collecting pipe 8 is coupled to a throttle body 10 having throttle valve 9 for adjusting air quantity (air intake quantity) which is suctioned into the engine 1. Furthermore, each of an air cleaner 11 and an air intake duct 12 is positioned upstream from the throttle body 10. An air intake passage 13 of the engine 1 is constituted by the air intake manifold 6, the throttle body 10, the air cleaner 11, and the air intake duct 12.

An injector (fuel injecting apparatus) 14 is positioned in correspondence to each of the cylinders 3 in the engine main body 2. The injector 14 has an electromagnetic fuel injection valve which faces a combustion chamber. By operation of the injector 14, a predetermined quantity of fuel is directly injected into the combustion chamber. In other words, the engine 1 is configured as a direct cylinder fuel-injected engine. Each injector 14 is supplied with the fuel which is drawn from a fuel tank 15 by a fuel pump 16 and which is subjected to a pressure adjustment.

An air intake valve 18, an exhaust valve 20, and spark plug 21 are positioned in correspondence to each of the cylinders 3 in the engine main body 2. The air intake valve 18 is for opening and closing the opening portion formed on a combustion chamber side in the air intake port 5. The exhaust valve 20 is for opening and closing the opening portion formed on a combustion chamber side in a exhaust port 19. The spark plug 21 makes an ignition electrode section face the combustion chamber. The spark plug 21 is appropriately controlled by an ignition timing in accordance with the output of a magnetic sensor 22 which detects the rotational angle of a flywheel (crank shaft 25). The opening and closing operations are controlled in each air intake valve 18 and exhaust valve 20 by a cam shaft which is not illustrated. Incidentally, an exhaust manifold 23 is connected to the external opening portion of each exhaust port 19.

The pistons 4 are connected to the crank pins of the crank shaft 25 through con-rods 24.

When the throttle valve 9 opens in the operational status of the engine 1, the outside air is drawn from the air intake passage 13 into the cylinder 3 in accordance with inhalation negative pressure in the cylinder 3 on the air intake step. In other words, the air intake valve 18 opens and the piston 4 goes down from a top dead center to a bottom dead center in the air intake step. After the air intake valve 18 closes in the cylinder, the fuel is injected from the injector 14 in the air which is compressed by the rising of the piston 4, and the mixture of fuel and air starts combustion by the spark of the spark plug 21. Incidentally, the quantity of fuel, which is injected from the injector 14, is adjusted in accordance with the quantity of air which is suctioned into the cylinder 3. Combustion energy obtained by the combustion of the fuel-air mixture pushes down the piston 4 and makes the crank shaft 25 rotate.

A control circuit (control section) 26 controls the quantity of fuel injection and the timing of fuel injection under the operational status of the engine 1. The control circuit 26 is a so-called ECU (Electronic Control Unit) and includes a CPU (Central Processing unit), a ROM (Read Only Memory) and the like. The control circuit 25 is supplied with power from a battery 27 to operate. The control circuit 26 carries out a predetermined process in accordance with input data given by output currents supplied from air flow meters (air flow rate sensors) 28 which are mounted on the branch pipes 7 of the air intake manifold 6 and which are positioned downstream from the throttle valves 9 of the throttle bodies 10 to output a command signal to each section.

Each of the air flow meters 28 is a sensor which is capable of detecting the quantity of air suctioned into the engine 1, as a mass flow rate. As a preferred air flow meter in the embodiment, there is a sensor in which a platinum thin film is evaporated onto a silicon substrate and in which the platinum thin film is energized so as to keep the platinum thin film at a constant temperature. Since the temperature is reduced in the platinum thin film when the mass of air which passes through the surrounding of the platinum thin film increases, the air flow meter 28 increases a current supplied to the platinum thin film, in order to keep the platinum thin film at a constant temperature. Since the temperature rises in the platinum thin film when the mass of air which passes through the surrounding of platinum thin film decreases, the air flow meter 28 decreases the current supplied to the platinum thin film. As described above, it is possible to measure the air flow rate when monitoring the amperage, because the amperage increases and decreases in proportion to the fluctuation in the mass of air which passes through the surrounding of the platinum thin film.

Since the air flow meter 28 is positioned downstream from the throttle valve 9, it is possible to measure the quantity of only air which is suctioned into the engine 1, excluding air filled in the region positioned downstream from the throttle valve 9 in the air intake passage 13. More particularly, it is possible to reduce a measuring error based on the quantity of air which is filled in the air intake manifold 6 having a comparatively large volumetric capacity, because the air flow meter 28 is mounted on the branch pipe 7 which is positioned downstream from the air intake manifold 6. In addition, it is possible to directly measure the quantity of air intake at each cylinder 3 of the engine 1, because the air flow meter 28 is mounted on each branch pipe 7.

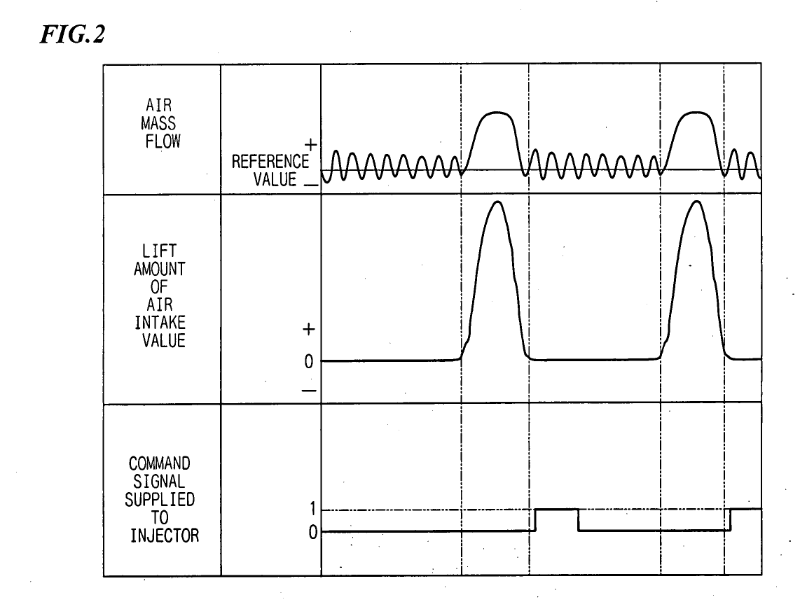

Next, a description will be given of data processing by the control circuit 26 and the command signal supplied to each section, with reference to graphs illustrated in FIG. 2. In the graphs illustrated in FIG. 2, the horizontal axis corresponds to time. The vertical axes correspond to a variation of the air flow rate based on the operation of the engine 1, a variation of lift amount in the air intake valve 18, and a variation of the command signal supplied to the injector 14 in accordance with the variation of the air flow rate.

The air flow rate is calculated on the basis of the current outputted from the air flow meter 28. When the command signal supplied to the injector 14 is representative of “0”, the fuel injection valve closes and the fuel injection is not carried out. When the command signal is representative of “1”, the fuel injection valve opens and the fuel injection is carried out. In addition, when the lift amount of the air intake valve 18 is representative of “0”, the air intake valve 10 closes. When the lift amount of the air intake valve 18 is greater than “0”, the air intake valve 18 opens with an opening level based on the lift amount.

The air flow rate, which varies in accordance with the lapse of time, is obtained by multiplying the current outputted from the air flow meter 28 by a predetermined coefficient. When the obtained air flow rate is greater than a predetermined reference value, the air flow will be called a forward flow. When the obtained air flow rate is not greater than the predetermined reference value, the air flow will be called a reverse flow.

In the forward flow, the air flows in a direction in which the air is suctioned into the engine 1. In the reverse flow, the air flows in a direction which is the reverse of the forward flow. In other words, the air flows in a direction towards the throttle valve 9, in the reverse flow. Incidentally, the reverse flow occurs because the retained air flows in the reverse direction on closing the air intake valve 18.

The state in which the forward flow and the reverse flow alternatively occur may be called a pulsating flow, and the air intake valve 18 closes in this state. The region in which the air flow rate exceeds a range of pulsating flow is a region in which the air is suctioned into the engine 1. In other words, the above-mentioned region corresponds to the air intake step in the engine 1. In the air intake step, the air intake valve 10 opens. When calculating a sum of air flow rate which exceeds the reference value in the region in which the air flow rate exceeds the range of pulsating flow, a total air intake quantity is obtained in the engine 1 with respect to the air intake step.

The engine 1 starts the air intake when the air flow rate exceeds the upper limit value of the pulsating flow range. At that time, the valve lift amount arises from a state of “0” and the air intake valve 18 starts increasing the opening level, namely, the air intake valve 18 opens.

When the air flow rate, which exceeds the upper limit value of the pulsating flow range, returns back to the pulsating flow range, the air intake step ends. At that time, the valve lift amount reduces together with the decrease of air flow rate and returns back to the state of “0”. Namely, the air intake valve 18 closes.

The leading edge of air intake, which is representative of the start of the air intake in the engine 1, periodically appears in accordance with the operation of the engine 1. The period in which the leading edge of air intake occurs corresponds to one cycle with respect to one cylinder 3. Therefore, it is possible to determine a rotational angle of the crank shaft 25 in a case of detecting a lapse time from the occurrence of the leading edge of air intake. The rotational angle may be, for example, a rotational angle corresponding to the ignition timing of the air-fuel mixture. In addition, it is possible to determine the number of revolutions and the rotational speed with respect to the engine 1 when counting the number of leading edges with respect to the air intakes which occur during a predetermined time duration.

The command signal supplied to the injector 14 varies from “0” to “1” during a prescribed time duration from the instant when detecting the leading edge of air intake. During the prescribed time duration, the injector 14 injects the fuel into the combustion chamber. The prescribed time duration is a time duration in which it is necessary for the injector 14 to inject a necessary injection amount of fuel calculated in accordance with the total air intake quantity. Incidentally, the necessary fuel injection quantity is obtained by multiplying the total air intake quantity by an air-fuel ratio.

Since the engine 1 is a direct cylinder fuel-injection type, it is possible to carry out the fuel injection in accordance with a measured total air intake quantity within one cycle of the engine 1 in real time, in a case of measuring the quantity of air suctioned into the engine 1, namely, the total air intake quantity between the instant when the air intake valve 18 opens and the instant when the air intake valve 18 closes.

Incidentally, the control circuit 26 carrying out the above-mentioned process includes air flow rate calculating means for multiplying the current outputted from the air flow meter 28 by the predetermined coefficient to obtain the air flow rate, air intake judging means for judging the direction in which the air flows, the start of air intake, and the end of air intake, total air intake quantity calculating means for calculating the sum of air intake quantity in the air intake step, and fuel injecting quantity control means for calculating the fuel injecting quantity in accordance with the total air intake quantity to control the injector on the basis of the total air intake quantity.

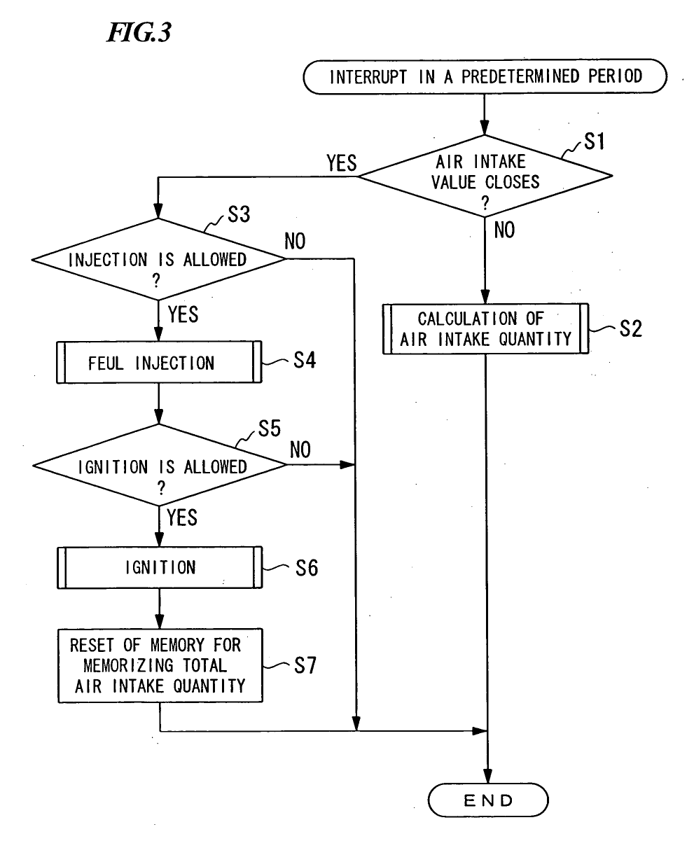

Next, a description will be given of the processing carried out by the control circuit 26, with reference to a flow chart illustrated in FIG. 3. The process is repeatedly carried out as an interrupt process at predetermined periods after the engine 1 starts.

At first, a judgment is made with respect to whether or not the air intake valve 18 closes, at a step S1. In a case where the air intake valve 18 opens (No in the step S1), namely, in a case where the engine 1 carries out the air intake step, the process proceeds from the step S1 to a step S2 in order to calculate the air intake quantity. The step S2 calculates the quantity of air intake on the basis of the current outputted from the air flow meter 28. The step S2 ends after memorizing the calculated result in a memory.

When the process again starts, the process proceeds from the step S1 to a step S3 in a case where the air intake valve 18 closes (YES in the step S1), namely, in a case where the air intake step ends in the engine 1. At that time, the calculated result of air intake quantity, which is memorized in the memory, becomes the total air intake quantity. In a case where the fuel injection is allowed (YES in the step S3), the process proceeds from the step S3 to a step S4. A fuel injection is carried out at the step S4. In a case where no fuel injection is allowed (NO in the step S3), the process ends. In the fuel injection of the step S4, the fuel injection quantity is determined so as to make the ratio of the fuel to the total air intake quantity become a predetermined ratio (air-fuel ratio). In accordance with the determined fuel injecting quantity, the command signal is supplied to the fuel injecting pump 16 and the injector 14.

The process proceeds from the step S4 to a step S5. In a case where the ignition is allowed (YES in the step S5), namely, in a case of detecting the ignition timing in accordance with the rotational angle of the crank shaft 25 that is outputted from the magnetic sensor 22, the process proceeds from the step S5 to a step S6 at which the ignition is carried out. In other words, the ignition of the air-fuel mixture is carried out in order to bum the air-fuel mixture. In a case where no ignition is allowed (NO in the step S5), the process ends, After ignition, the process proceeds from the step S6 to a step S7 at which a reset is carried out with respect to the calculated result of air intake quantity memorized in the memory. The process ends after the step S7.

The above-mentioned process is repeatedly carried out at the predetermined periods. Real time control is carried out with respect to the calculation (step S2) of the total air intake quantity and the fuel injection (step S4) based on the total air intake quantity.

According to the above-mentioned embodiment, it is possible to measure only air which is suctioned into the engine 1 excluding the air filled in the air intake passage 13, even at the start of opening of the throttle valve 9, because the quantity of air suctioned into the engine 1 is measured by the air flow meter 28 which is positioned downstream from the throttle valve 9 located in the air intake passage 13. Furthermore, it is possible to carry out the fuel injection based on the measured air intake quantity within one cycle of the engine 1 in real time after measuring the quantity of air, namely, the total air intake quantity which is suctioned into the engine 1 between the instant when the air intake valve 18 opens and the instant when the air intake valve 18 closes, because the engine 1 is the direct cylinder fuel-injection type. As a result, it is possible to detect the air intake quantity with high accuracy and to perform optimizations with respect to the fuel injecting quantity. It is possible to enhance the combustion efficiency with respect to the air-fuel mixture and to improve the responsiveness and the fuel efficiency of the engine 1.

In addition, it is possible to determine the start and the end of air intake, to calculate the air intake quantity and fuel injecting quantity, and to control the fuel injection timing on the basis of the information obtained by the air flow meter 28. Accordingly, it is possible to reduce a memory capacity of the control apparatus that is necessary in a fault diagnosis program, in comparison to a control apparatus using a plurality of sensors. Furthermore, it is possible to reduce the processing load with respect to the CPU. In a case of taking an entire engine control system into consideration, flexibility increases in terms of layout and it is possible to reduce the number of man-hours required for assembly.

Furthermore, it is unnecessary to carry out a complex calculating process such as determining the fuel injecting quantity at each pressure and the number of revolutions of the engine 1, because the fuel injecting quantity is determined in accordance with the measured air intake quantity even if the opening and closing timings vary on the basis of the number of revolutions of the air intake valve 18 in the engine 1.

Incidentally, the present invention is not limited to the above-mentioned embodiment. For example, the air flow meter 28 can be mounted on the branch pipe 7 corresponding to any one of the cylinders 3 of the air intake manifold 6 and the air intake quantities of the other cylinders may be determined by estimation in accordance with the air intake quantity of the cylinder 3 having the air flow meter 28. Similarly, it is possible to mount the air flow meter 28 on only one collecting pipe 8 of the air intake manifold 6. Furthermore, the present invention is applicable to an engine having an individual throttle body 10 at each of the cylinders 3 and is applicable to a single-cylinder engine, without using the air intake manifold 6.

In addition, the control circuit 26 may control the ignition timing of the engine 1 in accordance with the information obtained by the air flow meter 28, although the ignition timing of the engine 1 is determined by the magnetic sensor 22 which monitors the rotational angle of crank shaft 25, in the above-mentioned embodiment.

### INDUSTRIAL APPLICABILITY

The present invention relates to a control apparatus for an internal combustion engine of the direct cylinder fuel-injection type that directly injects a fuel in a combustion chamber of a cylinder. The control apparatus includes an air flow rate sensor which is positioned downstream from a throttle valve located in an air intake passage of the internal combustion engine and which measures a quantity of air suctioned into the internal combustion engine, and a control section which calculates a fuel injecting quantity in accordance with measurement information outputted from the air flow rate sensor and which outputs a signal to a fuel injecting device of the internal combustion engine.

According to the control apparatus for internal combustion engine of the present invention, it is possible to detect the air intake quantity with high accuracy and to perform optimizations with respect to the fuel injecting quantity, even at the start of opening of the throttle valve. In addition, it is possible to enhance the combustion efficiency with respect to the air-fuel mixture and to improve the responsiveness and the fuel efficiency of the internal combustion engine

Furthermore, it is possible to reduce the number of sensors and to reduce the number of man-hours with respect to design and setting, because it is possible to determine the start and the end of air intake, to calculate the air intake quantity, and to control the fuel injection timing on the basis of the information obtained by the air flow rate sensor, in the internal combustion engine.

1. A control apparatus for an internal combustion engine having direct cylinder fuel-injection type that directly injects a fuel in a combustion chamber of a cylinder, comprising:
an air flow rate sensor which is positioned downstream from a throttle valve located in an air intake passage of the internal combustion engine and which measures a quantity of air suctioned into the internal combustion engine; and
a control section which calculates a fuel injecting quantity in accordance with measurement information outputted from the air flow rate sensor and which outputs a signal to a fuel injecting device of the internal combustion engine.
